(19) United States
(12) Patent Application Publication
(10) Pub. No.: US 2015/0127752 A1
(43) Pub. Date: May 7, 2015

(54) INTELLIGENT MESSAGING METHOD, APPARATUS AND COMPUTER-READABLE STORAGE DEVICE

(71) Applicant: CHUAN-HSING KUO, NEW TAIPEI CITY (TW)

(72) Inventor: CHUAN-HSING KUO, NEW TAIPEI CITY (TW)

(21) Appl. No.: 14/071,290

(22) Filed: Nov. 4, 2013

(51) Int. Cl. H04L 12/58

(52) U.S. Cl. CPC H04L 51/046
USPC 709/206

(57) ABSTRACT

Disclosure herein is related to an intelligent messaging method, an apparatus, and a computer-readable storage device. The method includes firstly acquiring selection of message recipients from an address book when a user manipulates a messaging program. The method essentially includes configuring the message transmitted to the multiple recipients selected from the address book in the communication device. The next step in the method is to determine the messaging means corresponding to the every recipient. After that, according to a messaging scenario, the method simultaneously initiates the step of transmitting the message to the recipients using the every recipient's corresponding messaging means. Personalized information may be applied to the message individually for the every recipient while the message is sent.

### BACKGROUND OF THE INVENTION

1. Field of the Invention

The present invention is generally related to an intelligent messaging method, an apparatus, and a computer-readable storage device; in particular, a messaging analysis program is introduced to integrating address book in the user's device and the various messaging software adopted by recipients, thereby implementing the intelligent message apparatus and method.

2. Description of Related Art

For the purpose of marketing, or establishing relationship with many people, tool for preparing sending messages to a large number of recipients is generally in demand.

According to the conventional ways, it always spends time on making up the business cards that are exchanged with other people in certain social situations. Those business cards include the information required to be transferred to the personal notes or address book. One of the conventional ways is to use a program specified to convert the information into the content of address book. For example, a business card scanner has been provided in the market for scanning and recognizing the content on the business card, and automatically storing the content to the address book.

However, even though many known schemes have already been developed for arranging the contacts for business, it still lacks efficient tool to keep the contacts by follow-up actions. The one of traditional schemes is to send one-by-one message or group message to the recipients, for example the electronic mail and SMS message. In general, people may keep the close relationship by forwarding shared articles or send blessing messages on occasion. Further, people may use specific software program to send the personalized messages by substituting the subject/title to the recipients in an automatic way.

Reference is made to FIG. 1. FIG. 1 shows the conventional ways provided for user to select one of various messaging methods to send messages to many people. A shown communication device 10 is such as an electronic device capable of communication. For example, the electronic device, such as smart phone or tablet computer, allows sending simple message over mobile communication network, or delivering messages over normal network.

Firstly, the user may choose one or more recipients to be messaged by the device 10. Next, one method is selected to conduct the messaging to the chosen recipient(s). For example, the legacy electronic mail 101 allows the user to send message to many recipients 120 at one time. In addition to sending mobile simple message 103, for example SMS message, the communication software 102, such as the well-known WhatApp™, Line™, WeChat™, Viber™, or the like, executed in the communication device 10 is provided for the user to send message to one or more recipients 120 over network.

### SUMMARY OF THE INVENTION

In view of the limitation in the conventional technologies that allow only one scheme to send messages to many recipients at one time, provided in accordance with the present invention are an intelligent messaging method, apparatus, and a computer-readable storage device.

The method performing the messaging in accordance with the present invention introduces a messaging analysis program to determining the individual messaging means corresponding to the every messaging recipient. The messaging analysis program integrates address book recorded in the user's equipment, and the information related to the messaging software adopted by the every recipient. Refer to the every messaging recipient's past messaging ways, in the method, the any messaging means with respect to the recipient is automatically switched according to the condition of last successful messaging.

In the intelligent messaging method, the related steps include setting one or more messages desired to be sent to the selected messaging recipients from a communication device; determining individual messaging means with respect to the every recipient; and sending the messages to the messaging recipients by their corresponding messaging means according to a messaging scenario.

The multiple messaging recipients are selected from one or more groups, or selected individually from the address book recorded in the communication device. The message sent to the every messaging recipient may be personalized by replacing personalized information.

The messaging means with respect to the messaging recipient is the one selected from multiple means associated with the every messaging recipient. The multiple messaging means are configured to be selected in an order. The order is configured according to a preference, or messaging history associated to the every messaging recipient. The order to select the messaging means is made by switching to the messaging means in higher order when the messaging means in lower order fails.

According to one of the embodiments of the intelligent messaging apparatus, a memory for storing the instruction set for performing the intelligent messaging is included. The instruction set at least includes instruction for retrieving multiple messaging recipients selected from the intelligent messaging apparatus; instruction for determining individual messaging means for every selected messaging recipient; and instruction for sending messages to the multiple messaging recipients according to the determined messaging means with respect to the every messaging recipient.

In one further embodiment of the present invention, the instruction set stored in the memory further comprises: instruction for confirming whether or not the message is successfully sent, or the message received by the every messaging recipient successfully; or instruction for recording history of sending message to the every messaging recipient.

Disclosure is further related to a computer-readable storage device used to store the program for performing the above-referred method.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 schematically shows various messaging types in the conventional technology;

FIG. 2 schematically shows an intelligent messaging apparatus integrated with multiple messaging technologies in one embodiment of the present invention;

FIG. 3 shows a schematic diagram illustrating software module adopted in an intelligent messaging method according to one embodiment of the present invention;

FIG. 4 shows a flow chart illustrating determining the messaging means in the intelligent messaging method according to one embodiment of the present invention;

FIG. 5 shows a flow chart illustrating steps to determine the messaging method in the method according to the embodiment of the present invention;

FIG. 6 shows a schematic diagram illustrating cloud backup scheme applied to the intelligent messaging method in one embodiment of the present invention;

FIG. 7 schematically shows one screen shot as initiating the intelligent messaging method in accordance with the present invention;

FIG. 8 schematically shows one further screen shot as initiating the intelligent messaging method in accordance with the present invention;

FIG. 9 schematically shows another screen shot as initiating the intelligent messaging method in accordance with the present invention;

FIG. 10 shows a flow chart illustrating the steps of intelligent messaging method in accordance with one embodiment of the present invention;

FIG. 11 shows one further flow chart illustrating the intelligent messaging method in accordance with one embodiment of the present invention.

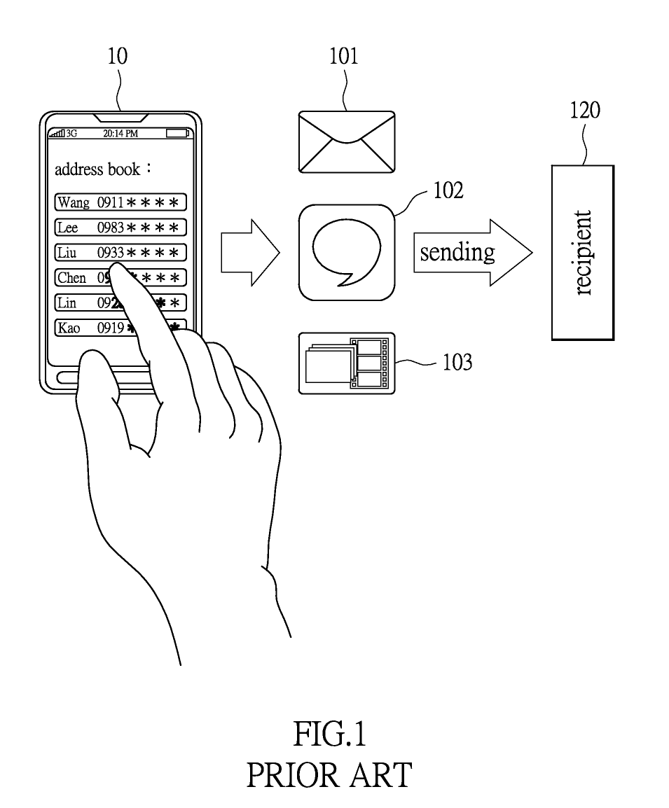

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In response to the requirement of simultaneously or at a very short time sending multiple messages, a specific messaging means associated to the every messaging recipient should be selected from the many software adopted by the recipient according to the conventional technology. However, the message may not be efficiently sent by the selected means to the recipient instantly. One of the reasons is that the few undelivered messages may be ignored since the large number of messages are sent at one time; or the returning erroneous messages may be received after a while when the messages fail to reach the recipients. For example, the any reply including the failure of delivering the message from the recipient may be received after a while because of, for example, the failure made to the mail box, email server or network.

The mentioned action of sending a large number of message at one time or within a specific period of time may be made in need of marketing, or establishment of relationship among many people. For example, the staff responsible for trading insurance, securities, futures, cars, realty or financial management in the various fields, salesman, or the businessman who needs to expand his connections.

The disclosure of the present invention is related to an intelligent messaging method, apparatus and a computer-readable storage device that provide a solution to embody various messaging means made by software or specific hardware. In particular, the solution is such a method to launch an instruction to simultaneously deliver messages to every recipient by individual messaging means recorded in an address book. The message delivered to the every recipient may be personalized automatically.

In general, people prefer to maintain interpersonal relationships using their smart phones or tablet computers. The general messaging method is such as electronic mail, mobile simple message, or the increasingly widespread network-based software, for example Line™, WhatsAPP™, WeChat™, or the like. To the need of a variety of messaging methods, the intelligent messaging and the apparatus in accordance with the present invention are provided for integrating many messaging software by means of software or hardware. The method firstly analyzes the messaging software adopted by the every selected messaging recipient. The message to be delivered may be personalized according to the corresponding messaging recipient. At last, a suitable messaging means with respect to the recipient can be decided for the further delivery. It is worth noting that the software or hardware-based method may automatically switch to another messaging means when the previously-decided messaging means fails to reach the recipient.

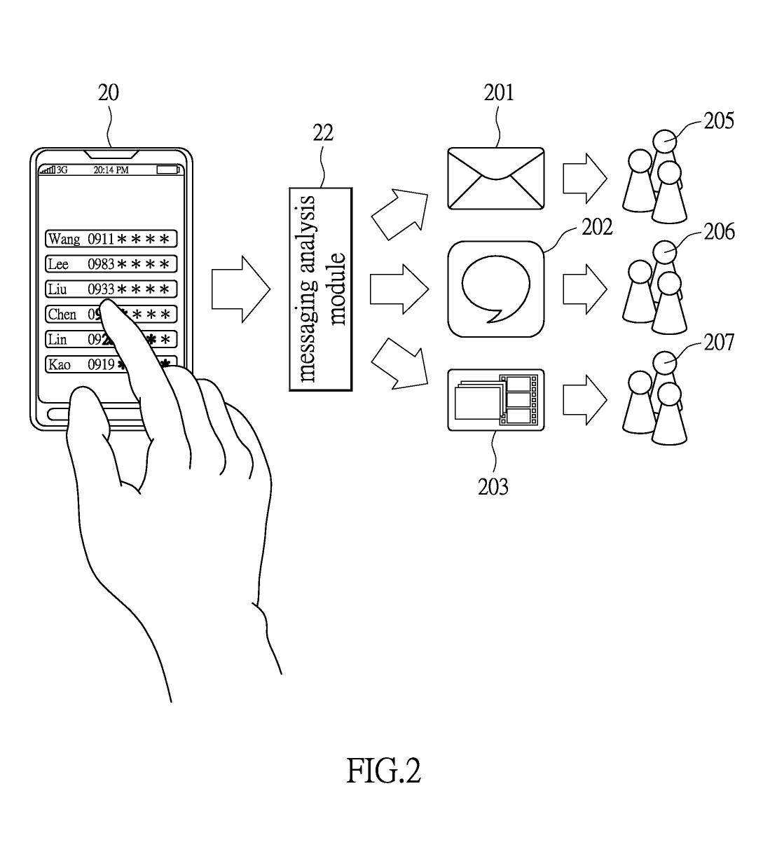

Reference is made FIG. 2 schematically depicting the intelligent messaging in one embodiment of the present invention.

The intelligent messaging apparatus is such as the shown communication device 20. The device 20 may be made by the smart cellular phone, tablet computer or the regular computer system device. The communication device 20 may be installed with a software module which is a software program for performing intelligent messaging. The related instruction set is stored in a memory of the communication device 20. The software module is such as the shown messaging analysis module 22. The software module may be a standalone program, for example a messaging analysis program. The messaging analysis program is a major scheme to determine the messaging means with respect to the every messaging recipient.

While the message has been drafted, the message can be delivered to the messaging recipients selected in the communication device 20 by their individual messaging means. The messaging analysis module 22 may analyze the past ways to complete of message delivery made by the every messaging recipient, the default way preset by the system, or the user's preference, so as to decide one messaging means. The shown first messaging means 201, second messaging means 202, and third messaging means 203 are schematically described as the recipient's possible means to message.

The general messaging means are such as legacy electronic mail, notification technology made by smart phone, mobile simple message, are the network-based messaging software. The network-based software are such as Skype™, WhatsAPP™, Line™, WeChat™, and Viber™. The mentioned messaging analysis module 22 may therefore analyze the messaging means adopted by the every messaging recipient as integrating the various messaging programs installed in the communication device 20. In an exemplary example, this module 22 may firstly send some test messages to the every recipient by the many possible messaging means for the analysis. The messages may be sent to the different recipients by different messaging means. The every messaging means may associate with different messaging recipients 205, 206, and 207 since the messaging recipients 205, 206, 207 support the one or more means adopted by the sender.

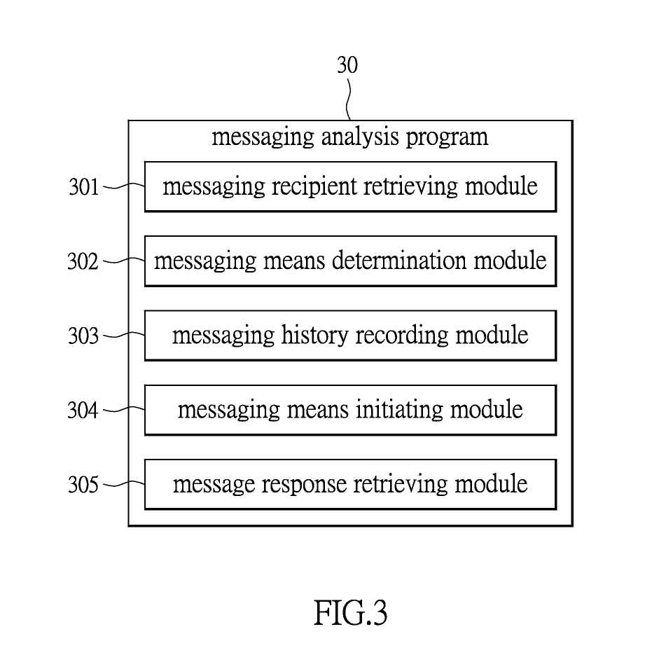

FIG. 3 depicts the software module in the program or the messaging analysis module mentioned above. The software module may be functionally described by several instructions that are implemented by the software. The assembly of the instructions forms an instruction set recorded in the computer-readable storage device.

The messaging analysis program 30 may be divided into a messaging recipient retrieving module 301, a messaging means determination module 302, a messaging history recording module 303, a messaging means initiating module 304, and a message response retrieving module 305 according to the various functions made by the program 30.

The messaging recipient retrieving module 301 is an instruction for the messaging analysis program 30 retrieving the messaging recipients selected from an address book in the intelligent messaging apparatus. Within the selected messaging recipients, the every messaging recipient may belong to one or more groups according his labels. The user may either select one group be the recipients at one time; or select persons labeled in one or more groups. Further, the recipients may also be the persons selected individually, or temporarily added.

The messaging history recording program 30 in the messaging analysis program 30 renders an instruction for recording history of past messaging records with respect to the every messaging recipient. The history includes the record of whether or not the specific messaging way is successful or failing at the past operations. The mentioned specific messaging way is one of the messaging means adopted by the messaging recipient. In the communication device may, an order is set among the messaging means with respect to the every messaging recipient. A preference may be referred to set the order. The preference may be made according to a fee schedule, network quality, or the user's configuration. The preference may also refer to the history made by the messaging analysis program 30.

The messaging means determination module 302 is used to determine the messaging means corresponding to the every messaging recipient. One or more messages may thereby be sent at one time with various messaging means. The adaptive messaging means with respect to the every recipient may be determined based on the history made by the messaging history recording module 303. For example, the address book may record one or more means adopted by the recipients, and the record is provided for determining the messaging means. The history may be an important reference to decide one means for rendering the messaging according to an order of ranking the many messaging methods.

The messaging means initiating module 304 is such as a software module that initiates the messaging means with respect to the every messaging recipient. The module 304 is also used to instruct sending message(s) to multiple recipients by their corresponding messaging means in the determination. While the one or more messages has been sent by the predetermined messaging means with respect to all the recipients, the messaging means initiating module 304 accordingly initiates the various messaging software. By this initiating module 304, the message(s) can be sent at one time to the multiple recipients. The messaging means initiating module 304 may still initiate the same software, the next or further means in accordance with the order if the process requires resending the message.

The message response retrieving module 305 is such as an instruction for confirming whether or not the message is successfully sent by the specified means. The module 305 may also instruct determining if the message successfully receives the recipient. In an exemplary example, the determination may be done by such an instruction for verifying if there is any response from the recipient within a specific time period. For example, the any response made by the messaging recipient, any failure or success information sent by the related server, or the internal signal indicating if the message is successfully sent by the software may be used to decide if the messaging analysis program 30 resends the message or another program is switched to process the next messaging.

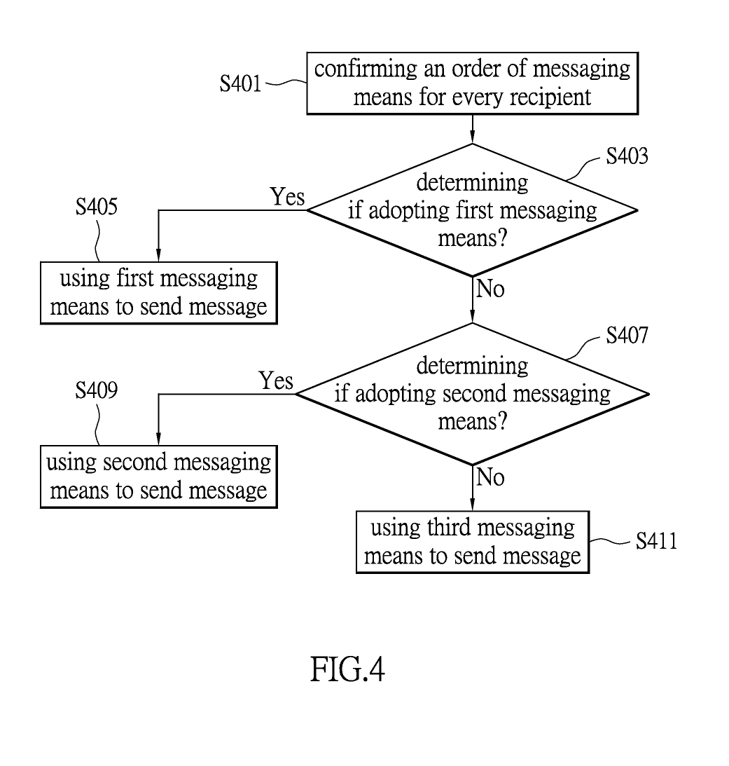

FIG. 4 shows a flow chart depicting the process of determining messaging means in the intelligent messaging method in one embodiment of the present invention.

In step S401, the step is to confirm an order of messaging means for every recipient, made by the aforementioned messaging analysis program or the software module in the messaging software, according to the user's address book, the or/and past history of messaging. It is determined, by the messaging means in the order, if the message can be successfully sent.

In step S403, it is determining if the recipient adopts a first messaging means. The determination is based on if the first messaging means successfully sends the message. For example, the messaging means may be preferably the network-based messaging software if the network operates normally for the communication device. That means the network-based messaging means is a major means made by the communication device. On the other hand, the legacy mobile simple message service may be employed if the messaging recipient does not use the network-based software. The electronic mail service may be selected since the message needs not to be sent instantly. The any selection made by in the method for messaging should be based on the actual requirement.

In the present example, the first messaging means is employed to send message(s) when both the sender and recipient supports the means based on approval of environment, e.g. network. Such as in step S405, the first messaging means is selected to send message; or another messaging means is adopted to process the messaging if the first messaging means fails. Next, in step S407, it is determined that if a second messaging means is supported by the both sides and the environment when the process automatically switches the means to the second messaging means.

The second messaging means is regarded as the main means to complete messaging, if the second messaging means is successfully switched in step S409.

The process may select the next one means, e.g. the third messaging means, in step S411, the third messaging means is automatically switched to send the message(s) if the above-mentioned messaging means fails. However, the above steps may be repeated in order to recheck the several messaging means when all the existed messaging means fail to send the message(s). A failure notice may be generated as failing to complete messaging after repeating the steps to check any available messaging means.

In an exemplary example, the network-based messaging software may have highest priority to be selected for the messaging, e.g. the first messaging means. One next network-based means may be set as the next priority. The traditional SMS service may be the last selection.

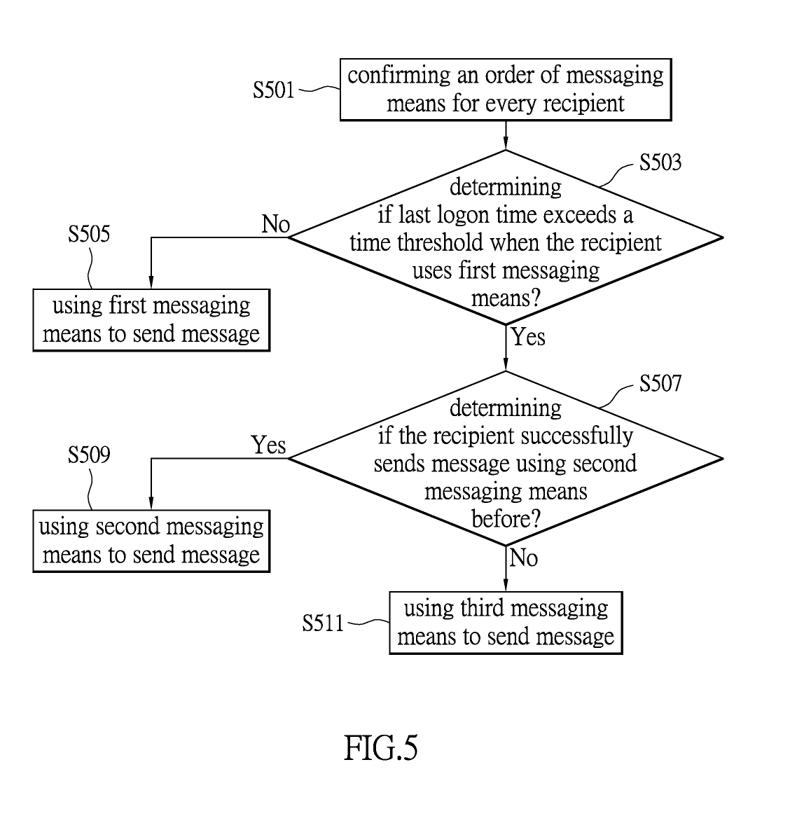

FIG. 5 shows one more flow chart depicting the process of determining the messaging means in the intelligent messaging method of the present invention. The present example describes the intelligent messaging method of the present invention more specifically.

In the beginning step S501, by means of software, an order of messaging means set for every recipient is confirmed. The order is preferably set according to the cost specified to the every messaging means. The network-based messaging means may be set as a major means since it is always the cheapest way. The traditional electronic mail or mobile simple message may be the next choice. Alternatively, the order may be based on the messaging recipient's past records.

The shown first messaging means may be implemented by a network-based program. In step S503, the method determines if last logon time exceeds a time threshold when the recipient uses the first messaging means.

If the logon time does not exceed the time threshold, that means there is not too long from the recipient's last logon time and presumes the first messaging means is often used by the recipient. As in step S505, the first messaging means is a preferred way for the recipient to send the message. On the contrary, the other messaging means, e.g. the second messaging means, is selected when the time of last login for first messaging means exceeds the time threshold. It also presumes the recipient did not use the first messaging means often.

In the meantime, the system automatically switches the method to the second messaging means. Next, in step S507, the process goes on determining if the recipient successfully sends message using the second messaging means before.

In the present embodiment, the second determination is based on the history recording the events that the messaging recipient sent the messages in the past. For example, it is determined if the history records the event that the second messaging means successfully sends the message. Such as in step S509, the system selects the second messaging means to send message when the history approves. However, when all the mentioned messaging means fail, such as in step S511, a third messaging means is switched to serve the messaging.

It is noted that the exemplary steps are not used to limit the applications made by the present invention. The steps may be adjusted according to the actual practice.

In particular, the intelligent messaging method, in one embodiment, may incorporate a cloud computing technology to backing up the address books, the contacts, and the histories for the potential recipients in all the terminal devices. Further, by the cloud computing technology, the user may utilize different devices to conduct the messaging, and the data may also be synchronized among the devices.

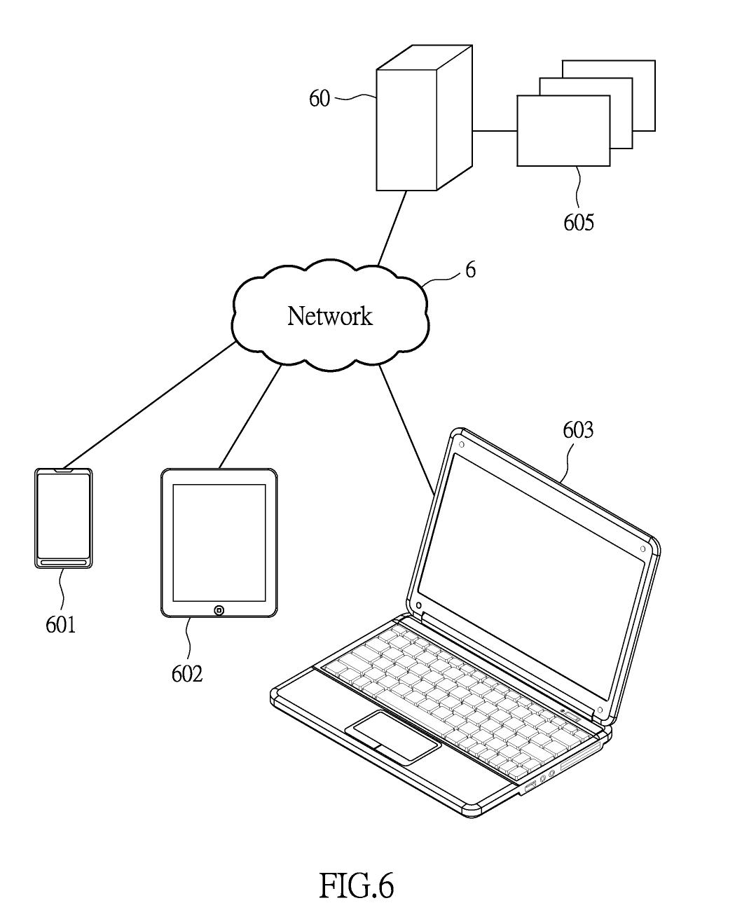

Reference is made to FIG. 6 showing a schematic diagram with various communication devices 601, 602, 603, such as smart phone, tablet computer, or the general computer. The communication devices 601, 602, 603 connect to a remote server 60 over network. The remote server 60 is used to back up the address book having contacts associated with the user. The record (605) stored in the remote server 60 may include the every recipient's past contact history with the specific messaging means. The record 605 may also indicate the past failing or successful records.

The server 60, according to one further embodiment, may back up the messages sent before, such as the messages, the associated messaging recipients, and the conditions of whether or not the messages are sent or received successfully.

Since the information are in cloud, the user may use different communication devices 601, 602, 603 to manage the address book stored in the server 60 directly, for example he is allowed to edit, add, or delete the content. The contacts in the address book may be labeled to be several groups. One contact may be labeled as one or more groups. The record 605 may include the various messaging means associated with the contacts who may use more than one device with different hardware or software.

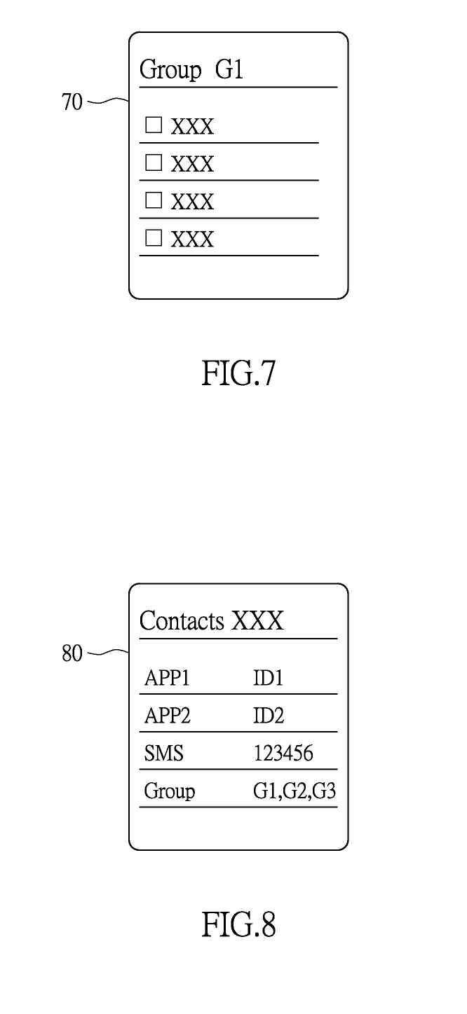

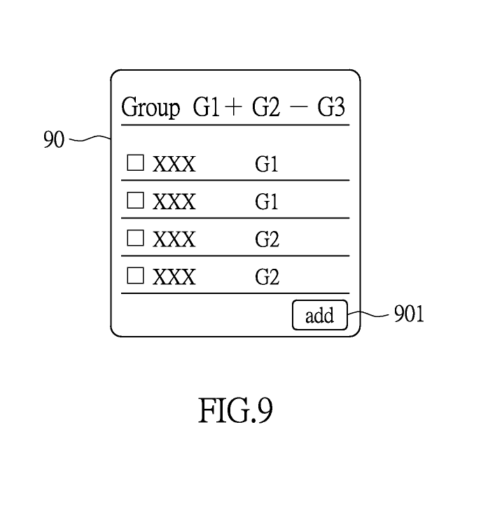

FIG. 7, FIG. 8, and FIG. 9 show the several schematic diagrams indicating the operating screens created by the intelligent messaging method. The operations are about the selection and display of the messaging recipients in the address book.

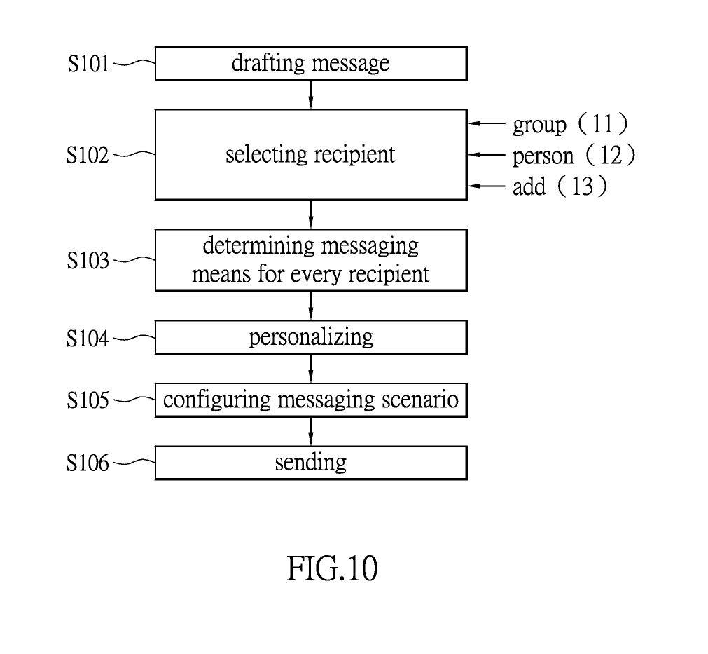

FIG. 7 shows a group page 70. The group G1 may have multiple contacts. The messages may be simultaneously sent to the contacts in the group G1 as initiating a group messaging. It is noted that the contacts within the same group may use different messaging means. The intelligent messaging method in accordance with the present invention allows sending messages to the different recipients with different means under an automatic selection. A messaging scenario may be introduced while the messages are sent. Further reference is made to FIG. 10. The every message may be personalized by replacing the personal information.

FIG. 8 schematically shows a contact page 80. In a communication device, the information of contacts may include the every contact's one or more messaging means. For example, ID1 indicates a recipient who uses APP1 to send the message; ID2 is the code indicative of messaging by APP2. If the general SMS service is as the messaging means, the telephone number may be the associated ID. The information may be retrieved by the messaging analysis module or program in the meantime of determining the messaging means with respect to the messaging recipient. It is noted that one contact may be labeled as groups G1, G2, G3 according to his attribute. The messaging recipients may be selected based on attributes associated to the recipients.

FIG. 9 shows a group selection page 90. The page 90 schematically indicates the every messaging recipient listed in the address book may belong to one or more groups (G1, G2, and G3). When the user selects the messaging recipients within the groups G1 and G2, the recipients may be removed from the list, or added by pressing an adding button 901. According to one further embodiment, the messaging recipients within the groups G1 and G2 may be firstly selected, and then removed one-by-one as requires. The logical operators may be incorporated to making the selection, for example selecting the recipients in both groups G1 and G2, but not in group G3 (G1+G2−G3). The operation may also associate the messaging means corresponding to the selected messaging recipient. The selection of messaging means also introduces an order of the multiple messaging means associated with individual recipient.

The flow chart shown in FIG. 10 illustrates the steps of processing intelligent messaging method according to one embodiment. The method is to send one or more messages to multiple recipients selected in a communication device. The messaging means specified to the every recipient is determined. In response to a messaging scenario, the method initiates step of sending the one or more messages to the messaging recipients by the messaging means determined with respect to the every messaging recipient.

In step S101, the one or more messages have been drafted. Next, in step S102, multiple messaging recipients are selected from an address book. The recipients are selected with the program guides or by the user's operation. One or more different messages is sent to the messaging recipients at the same time; or sent based on a messaging scenario. The message may be personalized by a program. The recipients may be selected from a group (11), or one-by-one selected from the contacts (12). Further, a new messaging recipient (13) may be temporarily added.

After that, the messaging analysis program executed in the communication device, or an analysis module installed in a specific messaging program is used to determine the messaging means with respect to the every selected recipient (step S103).

The mentioned messaging analysis program or the analysis module may determine the every recipient's messaging way according to a specific preset order, for example the method with lowest price may have highest rank to render the order. In general, the IP messenger such as WhatsApp™, Line™, WeChat™, Viber™, or other network-based messaging means may have the higher priority. The determination made by the messaging analysis program may also be based on the every messaging recipient's messaging history. For example, the records are such as the means with most successful times that would be set as the main messaging means for the specific contact. Further, the messaging history in view of the cost records may be a preferred reference to rank the many messaging means. However, the program still allows the user to make the order.

In next step S104, the messaging software or the module may personalize the messages to be sent by applying the personal information with respect to the every messaging recipient. For example, the every contact recorded in the address book has his name, title or nickname which is employed to be the personalized information. Further, the program allows the user to configure different personalized data for the different messaging means for each recipient. Exemplarily, a messaging scenario may be incorporated to the scheme, such as step S105. The scenario may be one set of setting, or in combination of several sets of setting for each messaging recipient. The setting is such as sending one or more messages at one time, sending one or more messages in batches, or at intervals. However, the messages need not to be sent out at the same time, but for different recipients with different messaging times based on the user's preference, in which the scheme may delay the messaging on purpose. When the messages are sequentially sent at adjustable intervals, it may prevent some messaging servers from regarding these messages as spam such as the advertisement or trash messages. In which, the messages specified to the different groups may be reserved to be sent at different times; or the messages are sent at different times in response to the different messaging means. Still further, the messages may be sent to the recipients orderly through their supported means if each messaging recipient adopts more than one messaging means. Further, the messaging program may make an arrangement of messaging based on idle or busy state of the communication device. For example, the messages are continuously sent when the system (the communication device system) is in idle state; or sending at intervals or stopping sending when the system is in busy state.

While the messaging means and messaging scenario set for every messaging recipient are confirmed, the program starts sending messages (step S106). The messages are sent to multiple messaging recipients at the same time, or initiating sending one or more messages to the messaging recipients according to the messaging scenario. In the process of messaging, the status thereof may be logged. The logs record the events of failure or success in the process. The program automatically records the current progress. When any accident occurs, for example picking up a phone call, receiving email, or unstable network, the process would be delayed. Then the messages will be sent at intervals when the communication device is in idle. Furthermore, the messaging means with lower ranking may process the messaging when the means with higher ranking fails in response to an order, which is set for ranking those messaging means.

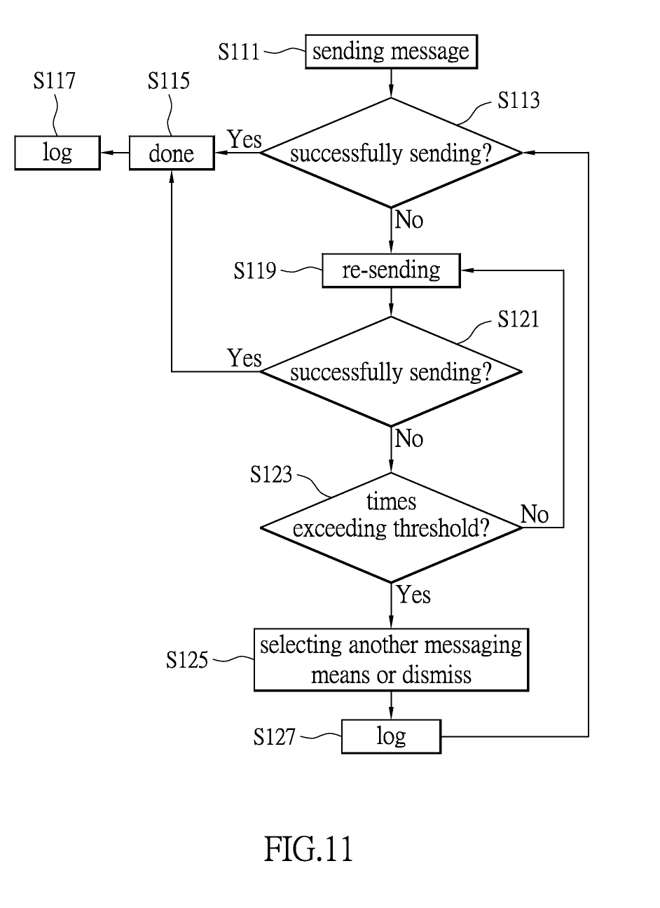

In the flow chart shown in FIG. 11, the further embodiment of the intelligent messaging method is described.

In step S111, the messages are sent when one of the messaging means is ready according to the foregoing configuration. The messaging recipient or any relay device, such as the messaging server or network router, may respond signal indicative of any messaging condition to the sender. For example, if the address is wrong as sending an electronic mail, the email server may reply an error message. If the network is unstable or fails, the related server may bounce back time out message. Therefore, the messaging software receives the message indicating the failure. If SMS service serves the messaging, the mobile messaging server may notice the sender with failure to reach the recipient. Further, if the network-based messenger is used, the notice indicating the failure when the network fails will be generated.

In step S113, the scheme determines whether or not the messages are successfully sent. The implement may not exclude other ways to make the determination in addition to determining if the recipient receives the message by the foregoing methods. For example, the sender may ask the response when the messaging recipient has received the message, by which the sender may check if the message is successfully sent. If it is determined that the message is successfully sent (yes), such as step S115, it appears that the current stage of messaging has been done. The process and result will be recorded (step S117). The record indicates that the message is successfully sent, or the messaging recipient can successfully receive the message by one of the messaging means. Therefore, the next messaging or the order to process the messaging will be performed based on the current record.

On the contrary, if the messaging fails (no), such as step S119, the same messaging means may be used to resend the message. The process may again determine if the resending by the same means is successful, such as step S121. The determination may be made by the foregoing methods. If the messaging is successful at this time (yes), in step S115, the record will record the result (step S117).

Otherwise, if the resending by the same means fails (no), such as step S123, every failure will be counted. The process may goes back to step S119 to repeat the messaging using the same means if the count of failures does not yet exceed a time threshold (no). The other messaging means is selected when the number of failures by the previous messaging means exceeds the time threshold, or abandoning the messaging (step S125). The process will be repeated from the beginning step S113 when the other messaging means is selected. The process including continuing messaging by the other messaging means, recoding, and determining if next means goes on the messaging will be recorded (step S127).

It is worth noting that, the messaging analysis program executed in the communication device is in charge of the step of determining the messaging means, and recording the process and result for the every messaging recipient. The records form the history to be the basis to determine the next messaging means. The records may be stored in a memory of the communication device, or the database located in a cloud server which is accessible to the various authorized devices.

In an exemplary embodiment, in the beginning of messaging, the messaging program determines if the last logon time for a specific messaging means by the associated messaging recipient exceeds a time threshold, for example 2 days. The next means such as SMS service may be performed if it is determined that the messaging recipient does not logon the service within the time threshold. In particular, the next messaging may automatically switch to the other available messaging means as it excludes the unavailable messaging means for this messaging recipient according to the current determination.

Thus, disclosure related to the intelligent messaging method, apparatus, and computer-readable storage device is provided for the user to send a large number of messages for many people at one time or intervals automatically. The process will automatically determine the available messaging means by applying the personalized information. The analysis program installed in the communication device is used to analyze the records including the every messaging recipient's messaging means. The records form the history which is as basis to determine the available messaging means. The intelligent messaging method in accordance with the present invention successfully renders a most efficient way to marketing, connections, establishing relationships with others, message sharing and so on.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An intelligent messaging method, comprising:
in response to multiple messaging recipients selected from a communication device, configuring one or more messages and determining individual messaging means corresponding to every selected messaging recipient;
in response to a messaging scenario, initiating step of sending the one or more messages to the messaging recipients by the messaging means determined with respect to the every messaging recipient.

2. The method according to claim 1, wherein the multiple messaging recipients are selected from one or more groups or one-by-one selected from an address book recorded in the communication device.

3. The method according to claim 2, wherein the message sent to the every messaging recipient is personalized by replacing personalized information.

4. The method according to claim 1, wherein the messaging scenario is one selected from, or in combinations of:
sending the one or more messages at one time;
sending the one or more messages in batches;
sending the one or more messages at intervals;
setting different messaging times for different messaging recipients;
reserving different times to send messages for different groups;
sending messages at different times in response to the different messaging means;
sending message to every messaging recipient with different messaging means in orders; and
sending the one or more messages based on idle or busy state of the communication device.

5. The method according to claim 1, wherein the every messaging means with respect to the messaging recipient is one of multiple means adopted by the messaging recipient.

6. The method according to claim 5, wherein the multiple messaging means are configured to be selected in an order.

7. The method according to claim 6, wherein the order is configured according to a preference, or messaging history associated to the every messaging recipient.

8. The method according to claim 7, wherein the preference is made according to fee schedule of the multiple messaging means.

9. The method according to claim 7, wherein the every messaging recipient's history includes past records of messaging, including the records of successfully sending the messages by every messaging means.

10. The method according to claim 9, wherein the order to select the messaging means is made by switching to the messaging means in higher order when the messaging means in lower order fails.

11. The method according to claim 10, wherein, before switching to the other messaging means, confirming the order to perform the messaging means with respect to the every messaging recipient recorded in an address book of the communication device, further comprising:
determining whether or not a first messaging means is successful, wherein:
sending the message by the first messaging means if the message is sent successfully by the first messaging means;
sending the message by the other messaging means if the first messaging means fails.

12. The method according to claim 11, wherein, the other messaging means is selected when the number of failures by the first messaging means exceeds a threshold.

13. The method according to claim 11, wherein, the other messaging means is selected when the time of last login for the first messaging means exceeds a time threshold.

14. The method according to claim 11, wherein the other messaging means is a second messaging means, further comprising:
determining whether or not the second messaging means is successfully, wherein:
sending message by the second messaging means if the message is successfully sent by the second messaging means;
sending message by one further messaging means if the second messaging means fails.

15. The method according to claim 14, wherein the first messaging means or the second messaging means is network-based messaging software.

16. An intelligent messaging apparatus, comprising:
a memory recording instruction set for performing intelligent messaging, wherein the instruction set includes:
instruction for retrieving multiple messaging recipients selected from the intelligent messaging apparatus;
instruction for determining individual messaging means for every selected messaging recipient; and
instruction for sending messages to the multiple messaging recipients according to the determined messaging means with respect to the every messaging recipient.

17. The apparatus according to claim 16, wherein instruction set recorded in the memory further comprises:
instruction for confirming whether or not the message is successfully sent.

18. The apparatus according to claim 17, wherein the instruction recorded in the memory further comprises:
instruction for recording history of sending message to the every messaging recipient.

19. The apparatus according to claim 17, wherein the instruction set is implemented by a standalone software program, or a software module within messaging software.

20. A computer-readable storage device, recording instruction set for performing intelligent messaging, comprising:
instruction for retrieving multiple messaging recipients selected from the intelligent messaging apparatus;
instruction for determining individual messaging means for every selected messaging recipient; and
instruction for sending messages to the multiple messaging recipients according to the determined messaging means with respect to the every messaging recipient.
